(19) United States
(12) Patent Application Publication
(10) Pub. No.: US 2019/0323640 A1
(43) Pub. Date: Oct. 24, 2019

(54) SLIDING HIGH PRESSURE PIPE CONNECTION

(71) Applicant: Schlumberger Technology Corporation, Sugar Land, TX (US)

(72) Inventors: Christopher Shane Lalumandier, Sugar Land, TX (US); Franz Aguirre, Sugar Land, TX (US)

(21) Appl. No.: 16/390,488

(22) Filed: Apr. 22, 2019

Related U.S. Application Data
(60) Provisional application No. 62/661,844, filed on Apr. 24, 2018.

(51) Int. Cl. F16L 27/12

(52) U.S. Cl. CPC F16L 27/12

(57) ABSTRACT

A coupler for conducting high pressure fluid between adjacent skids on an oil rig is disclosed. A coupler is rotatable relative to pipe segments that together form a fluid connection between the adjacent skids for transferring fuel or another fluid between the skids at a relatively high pressure and flow rate. Rotating the coupler causes the pipe segments to extend and contract to facilitate connection to the skids without the use of heavy equipment.

### CROSS-REFERENCE TO PRIOR APPLICATION

The present application claims priority to U.S. Provisional Patent Application No. 62/661,844 entitled SLIDING HIGH PRESSURE PIPE CONNECTION filed Apr. 24, 2018 which is incorporated herein by reference in its entirety.

### BACKGROUND

The current generation of rigs for use in the oil and gas industry frequently uses a modular system of skids that are trailer-like apparatuses that are connected together to achieve a desired functionality for the rig. There can be any number of skids housing any number of components. Many of these skids exchange fluid at a relatively high pressure and volume, presenting a problem if not properly handled. Currently most skids that are to exchange pressure of upwards of 1,000 psi is to use a high-pressure hose which has up to a 60″ bend ratio. Another method is to insert a piece of pipe onto one of the skids before installing the other skid. Both methods require the use of heavy equipment and are difficult to install without the use of a mechanical means of lifting and attaching. There is a need in the art for an improved system and method of providing a high-pressure fluid pathway between modular skids on an oil rig.

### SUMMARY

Embodiments of the present disclosure are directed to a coupling system for a fluid passageway, including a first pipe segment operably coupled to a first skid of an oil rig, and a second pipe segment operably coupled to a second skid of the oil rig adjacent to the first skid. The first and second pipe segments extend toward one another and are axially aligned. The coupling system also includes a coupler comprising a barrel portion, a first endcap coupled to the barrel portion and configured to threadably engage the first pipe segment such that rotation of the barrel portion causes the barrel portion to move axially relative to the first pipe segment, and a second endcap coupled to the barrel portion opposite the first endcap. The second endcap is rotatable relative to the second endcap at a fixed axial position relative to the second pipe segment. Rotation of the coupler in a first direction urges the pipe segments toward one another and rotation of the coupler in a second direction urges the pipe segments away from one another. The coupler is configured to conduct fluid at up to 10,000 psi and 1600 gallons per minute.

In further embodiments the coupler is configured to move continuously between a fully contracted position and a fully extended position defining a range of motion, and to withstand the fluid pressure throughout the range of motion.

Other embodiments of the present disclosure are directed to a coupler, comprising a barrel portion having a first end configured to couple with a first pipe segment and a second end configured to couple with a second pipe segment. Rotation of the barrel portion in a first direction urges the first and second pipe segments toward one another and rotation of the barrel in the second direction urges the first and second pipe segments away from one another along a range of motion defined by an extended and contracted position. The coupler also includes a first seal between the barrel portion and the first pipe segment and a second seal between the barrel portion and the second pipe segment. The coupler is configured to withstand 10,000 psi and 1,600 gallons per minute.

Still further embodiments of the present disclosure are directed to a method of conducting fluid between adjacent skids on an oil rig at up to 10,000 psi and 1,600 gallons per minute, including providing a coupler between the skids, the coupler having a barrel portion and pipe segments protruding from opposite ends of the barrel portion. The pipe segments extend and contract from the coupler when the coupler is rotated relative to the pipe segments. The coupler is sufficiently strong to withstand X fluid pressure and X flow rate. The method also includes coupling the coupler to adjacent skids, and rotating the barrel portion to extend and contract the pipe segments.

### BRIEF DESCRIPTION OF THE FIGURES

FIG. 1 is a schematic illustration of a high-pressure connection for modular skids on an oil rig according to embodiments of the present disclosure.

FIG. 2 is a schematic cross-sectional view of the coupler according to embodiments of the present disclosure.

FIG. 3 is a schematic cross-sectional view of an elongating coupler according to embodiments of the present disclosure.

FIG. 4 is a schematic cross-sectional view of a coupler according to further embodiments of the present disclosure.

FIG. 5 is yet another schematic cross-sectional view of a coupler according to further embodiments of the present disclosure.

FIG. 6 is a schematic cross-sectional illustration a coupler according to further embodiments of the present disclosure.

FIG. 7 is a schematic cross-sectional view of a telescoping portion according to embodiments of the present disclosure for use with a coupler as shown in FIG. 6.

### DETAILED DESCRIPTION

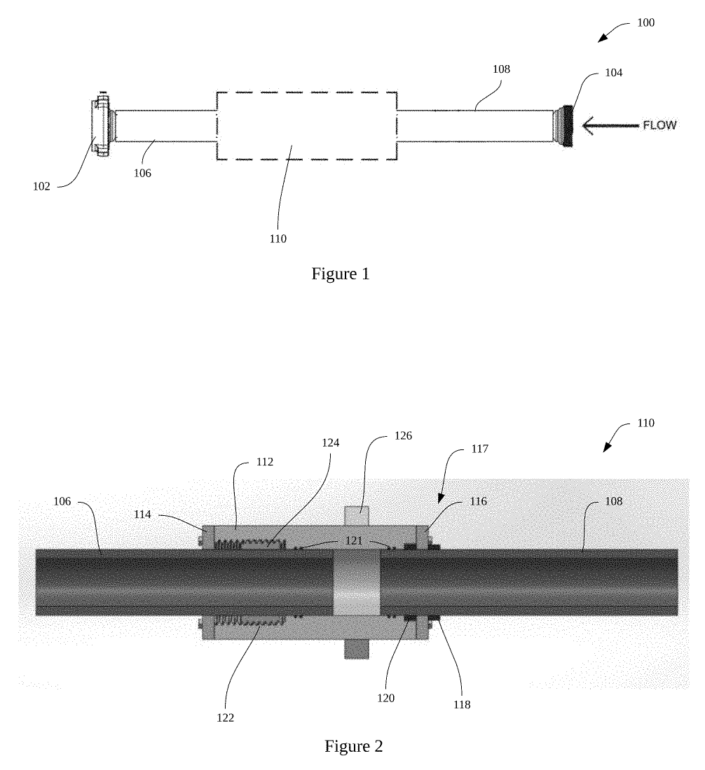

Below is a detailed description according to various embodiments of the present disclosure. FIG. 1 is a schematic illustration of a high-pressure connection 100 for modular skids on an oil rig according to embodiments of the present disclosure. The connection 100 includes a first connector 102 configured to couple to a first skid (not shown; would be positioned to the left of the connector 102) and a second connector 104 configured to couple to a second skid (not shown; would be positioned to the right of the connector 104). The connectors 102, 104 can be hammer unions or another suitable connector type. A first pipe segment 106 is coupled to the first connector 102, and a second pipe segment 108 is coupled to the second connector 104. The pipe segments can be a suitable size and strength to support a fluid flow of 1,000 psi or more. In some embodiments the fluid pressure can be up to 15,000 psi. In some embodiments the pipe segments can be approximately six inches in diameter and have a wall thickness of approximately ¾″ and can support a dynamic pressure of around 15,000 psi or more.

A coupler 110 is positioned between the first and second pipe segments and is configured to be operably coupled to the segments. The coupler 110 is configured to enable some flexibility in the length without compromising the fluid pressure handling capabilities. In some embodiments the coupler 110 can allow between four and six inches of lengthening along an axis defined by the center of the pipe segments. The pipe segments 106, 108 need not necessarily be concentric. The pipe segments can be of the same diameter or of different diameters. The flexibility provided by the coupler 110 enables adjacent skids to be coupled together using the first and second connectors 102, 104 which can be assembled easily at the rig site and without needing expensive, heavy-duty equipment. For example, if the connectors 102, 104 are hammer unions which are relatively straightforward to assemble.

FIG. 2 is a schematic cross-sectional view of the coupler 110 according to embodiments of the present disclosure. The coupler 110 includes a first endcap 114, a barrel 112, and a second endcap 116 opposite the first endcap 114. The endcaps can be bolted to the barrel 112. The second endcap 116 is positioned over the second pipe segment 108. A fixed swivel joint 117 is formed by seals 118 and 120 on either side of the endcap 116. The fixed swivel joint 117 permits the coupler 110 to rotate about the pipe segment 108, but prevents axial movement of the coupler 110 relative to the second pipe segment 108. The fixed swivel joint can be a high-pressure seal sufficiently strong to prevent leaks of the fluid inside the coupler 110.

On the opposite side of the coupler 110 the barrel 112 includes an interior threaded surface 122 which is configured to engage the first pipe segment 106 which has external threads 124. Rotation of the coupler 110 therefore causes axial movement of the coupler 110 relative to the first pipe segment 106, but not relative to the second pipe segment 108. Accordingly, rotating the coupler 110 causes elongation of the connector. The barrel 112 can also include wings 126 that enable rotation of the barrel 112. Seals 121 can be positioned between the barrel 112 and the pipe segments.

The coupler 110 has a range of motion from a fully contracted position and a fully extended position. The threads 124 and the seals 118 enable the coupler 110 to withstand fluid pressure inside without urging the coupler toward the fully extended position. The pitch and design of the threads and the material of the coupler 110 provide sufficient strength to withstand the pressure without exerting a force on the skids through the connectors. The fluid pressure (which can be extremely high) therefore does not push the skids apart. The coupler can be relatively easily moved throughout the range of motion by a simple rotation, and at any point continuously along the range of motion the coupler withstands the pressure within.

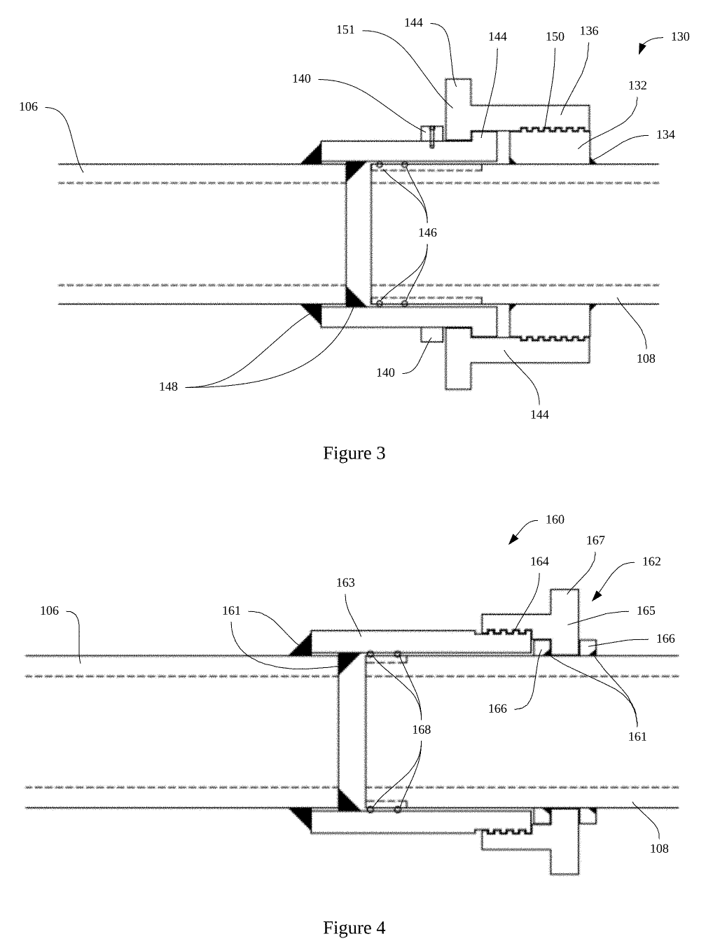

FIG. 3 is a schematic cross-sectional view of an elongating coupler 130 according to embodiments of the present disclosure. The elongating coupler 130 is configured to engage with a first pipe segment 106 and a second pipe segment 108. The elongating coupler 130 includes a ring 132 coupled to the second pipe segment 108 via welds 134 or another suitable attachment means. In some embodiments the pipe segment 108 can be manufactured to include the ring 132. The ring 132 includes threads 150 on an external surface. The elongating coupler 130 also includes a sleeve 138 coupled to the first pipe segment 106 via welds 148 or another suitable attachment means. The sleeve includes a shoulder 142 that has a larger diameter. The sleeve 138 also includes a ring 140 which can be bolted to the sleeve 138. The elongating coupler 130 also includes a barrel 136 that is configured to engage the threads 150 of the ring 132, and it includes a t-shaped end 151 that is configured to form a rotatable, axially-fixed connection with the sleeve 138. The ring 140 can be bolted to the sleeve 138 after attaching the barrel 136. The t-shaped end also has an outwardly-extending portion 144 that can be used to rotate the barrel 136 relative to the pipe segments 106, 108. The threads and the axially-fixed connection cause rotation of the barrel 136 to result in axial elongation by moving the pipe segments closer together or farther apart depending on the desired movement of the coupler 130. The elongated coupler 130 can also include seals 146 interior to the sleeve 138 and exterior to the pipe segment 108 that are sufficiently strong to withstand the fluid pressure that will pass through the coupler 130.

The fit between the t-shaped end of the barrel 136, the shoulder 142, and the ring 140 can be sufficiently loose to permit rotation, but sufficiently strong to withstand the pressure and other strain that will be placed on the coupler 130. The seals 146 can prevent the interior fluid pressure from reaching the connection between the barrel 136, sleeve 138, and ring 132. A lubricant can be used between the t-shaped end and the sleeve 138 to facilitate rotation.

FIG. 4 is a schematic cross-sectional view of a coupler 160 according to further embodiments of the present disclosure. The coupler 160 engages with a first pipe segment 106 and a second pipe segment 108. The coupler 160 includes a sleeve 163 that is attached to the first pipe segment 106 by welds 161 or another suitable attachment mechanism. The sleeve 163 has threads 164 on an external portion opposite the welds 161. The coupler 160 also includes a t-ring 162 that threadably engages with the threads 164 of the sleeve 163. The t-ring 162 has an inwardly-extending portion 165 that contacts the second pipe segment 108 and an outwardly-extending portion 167 that serves as wings to enable rotation of the coupler 160. The coupler 160 also includes a ring 166 comprised of two rings, one on either side of the inwardly-extending portion 165 that forms a rotatable joint that is fixed in an axial direction.

The ring 166 thereby permits rotation but limits elongation between the t-ring 162 and the second pipe segment 108. The threads 164 have a pitch that enables rotation of the t-ring 162 relative to the sleeve 163 to cause axial movement between the first and second pipe segments. The length of the coupler 160 and thereby the entire connector, which includes the coupler 160, the pipe segments 106, 108, and any connector on either end (not shown here; shown to great advantage in FIG. 1), to elongate. The coupler 160 also includes seals 168 between the second pipe segment 108 and the sleeve 163 that are sufficiently strong to withstand the pressure inside the pipe segments and the coupler 160. The coupler 160 can be manipulated using simple tools that need only rotate the coupler 160 relative to the sleeve 163 and to attach the connectors which can be as simple as hammer unions. The coupler 160 can be rated to support a very high fluid pressure. In some embodiments as much as 15,000 psi can be withstood by the coupler 160.

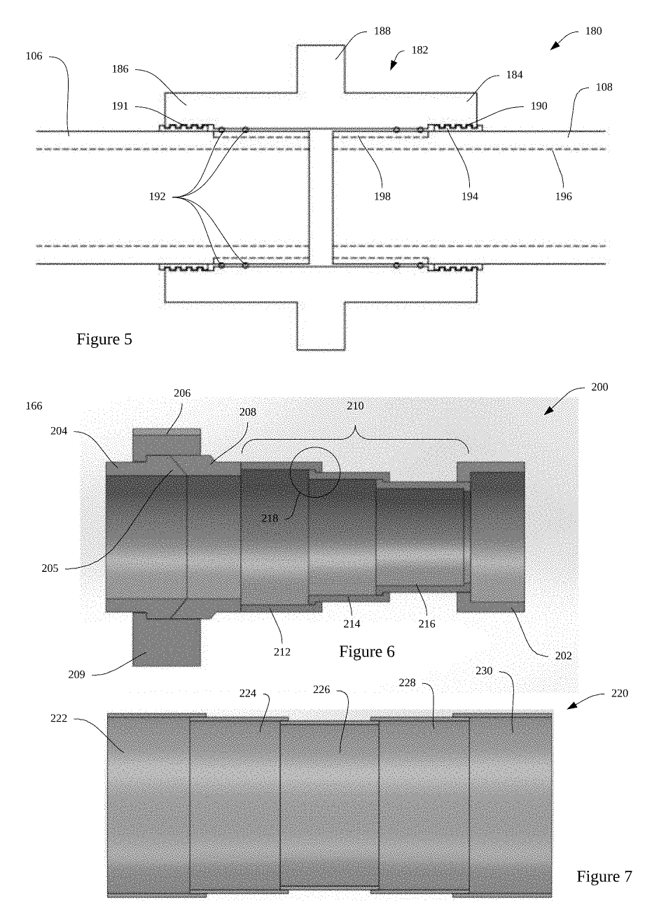

FIG. 5 is yet another schematic cross-sectional view of a coupler 180 according to further embodiments of the present disclosure. The coupler 180 is configured to engage with a first pipe segment 106 and a second pipe segment 108 which in turn are connected to a first and second skid (not shown), respectively, via a connector such as a hammer union (not shown). The coupler 180 can includes a barrel member 182 that has a first sleeve portion 186 that engages with the first pipe segment 106 and a second sleeve portion 184 that engages with the second pipe segment 108. The barrel member 182 also includes wings 188 that provide additional leverage for rotating the barrel member 182. In some embodiments the barrel member 182 can be symmetrical, but there are other embodiments in which the first sleeve portion 186 is larger or smaller than the second sleeve portion 184. The pipe segments 106, 108 can include external threads 190, 191, and the sleeve portions 186, 184 have internally-facing threads that couple thereto. The first threads 190 can be right-hand threads, and the second threads 191 can be left-hand threads, or vice versa such that rotation of the barrel member 182 causes the pipe segments 106, 108 to move toward or away from one another. The pitch of the threads can be chosen to suit a given application. The pitch of the first threads 190 can be different than the pitch of the second threads 191.

The coupler 180 can also include seals 192 that are sufficiently strong to withstand the fluid pressure that will be present inside the coupler 180. The threads 191, 190 can also be designed to at least partially contain the pressure inside the coupler 180. In some embodiments the threads are sufficiently strong to withstand the fluid pressure inside without the use of seals.

In some embodiments the pipe segments 106, 108 have a step 198 on an exterior surface which is a portion having a smaller outer diameter than the remainder of the pipe segments. The difference in diameter creates more space between the barrel member 182 and the pipe segments 106, 108 such that seals can be used between. The difference between the two diameters depends on the nature of the seals 192.

FIG. 6 is a schematic cross-sectional illustration a coupler 200 according to further embodiments of the present disclosure. The coupler 200 includes a first connector 202 at the right side and a second connector 204 at the left side of the figure opposite the first connector 202. The connectors are configured to couple to a fluid port on adjacent skids (not pictured) and conduct fluid flow through the coupler 200. The second coupler 204 can have a convex portion 205 at a distal end that has a sloping profile at the distal end. The coupler 200 can also include a corresponding concave portion 208 that engages with the convex portion 205. A securing ring 206 can be positioned over the intersection of the convex portion 205 and the concave portion 208. The securing ring 206 can have a shoulder 207 that engages with a corresponding shoulder on the convex portion 205 to maintain the securing ring 206 in position over the intersection. In some embodiments the securing ring 206 can slide with respect to the concave portion 205 to allow the convex portion 208 to be joined to the convex portion 205. The securing ring 206 can have sufficient strength to withstand the pressure within the coupler 200. In some embodiments the securing ring 206 can have a wing 209 that extends radially from the securing ring 206 to provide a greater moment arm for rotating the securing ring 206.

The coupler 200 can also include a telescoping portion 210 that includes a plurality of successively smaller portions 212, 214, and 216. There can be three, four, or five portions, or another suitable number of portions to suit a given application. The distance between skids can vary and having more or less portions will accommodate a larger or smaller distance, respectively. The portions of the telescoping portion 210 each include a shoulder interface 218 in which the larger portion has an inwardly-extending shoulder, and the smaller portion has an outwardly-extending shoulder that engages with the inwardly-extending shoulder to seal to withstand the pressure within, and to allow telescoping movement to expand or contract the coupler 200. The telescoping portion 210 can be screwed on with threads, or connected with welds.

FIG. 7 is a schematic cross-sectional view of a telescoping portion 220 according to embodiments of the present disclosure for use with a coupler as shown in FIG. 6. Viewed from left to right, the telescoping portion 220 has successively smaller portions including segment 222 and 224. There is a center segment 226 which is smaller than 224. The segments 222, 224, and 226 interface in a similar manner as the segments of telescoping portion 210 shown in FIG. 6, although the detail of the shoulders is not shown. The telescoping portion 220 also includes successively larger portions 228 and 230 which also interface in a similar way. The center segment 226 need not be at the center. In other embodiments there can be a different number of segments to the left of the center segment 226 as there are to the right. The center segment 226 is an inflection segment because the direction in which the segments expand changes at this segment. In other embodiments there can be more than one inflection segment. In some embodiments the segments can become successively larger and the inflection segment can be larger than adjacent segments. Any of these embodiments permit a high pressure fluid flow to move through the coupler between adjacent skids for an oil rig and provide sufficient flexibility to assemble and maintain the fluid passageway without the need for heavy expensive equipment.

The foregoing disclosure hereby enables a person of ordinary skill in the art to make and use the disclosed systems without undue experimentation. Certain examples are given to for purposes of explanation and are not given in a limiting manner.

1. A coupling system for a fluid passageway, comprising:
a first pipe segment operably coupled to a first skid of an oil rig;
a second pipe segment operably coupled to a second skid of the oil rig adjacent to the first skid, wherein the first and second pipe segments extend toward one another and are axially aligned; and
a coupler comprising:
a barrel portion;
a first endcap coupled to the barrel portion and configured to threadably engage the first pipe segment such that rotation of the barrel portion causes the barrel portion to move axially relative to the first pipe segment; and
a second endcap coupled to the barrel portion opposite the first endcap, the second endcap being rotatable relative to the second endcap at a fixed axial position relative to the second pipe segment;
wherein rotation of the coupler in a first direction urges the pipe segments toward one another and rotation of the coupler in a second direction urges the pipe segments away from one another; and
wherein the coupling system is configured to conduct fluid at 10,000 psi and 1,600 gallons per minute.

2. The coupling system of claim 1 wherein the coupler is configured to:
move continuously between a fully contracted position and a fully extended position defining a range of motion;
withstand the fluid pressure throughout the range of motion.

3. The coupling system of claim 2 wherein the coupler is further configured to withstand the fluid pressure at any position in the range of motion without causing the coupler to move toward the fully extended position.

4. The coupling system of claim 1, further comprising wings extending from the barrel portion configured to enable rotation of the coupler.

5. The coupling system of claim 1, further comprising seals between the barrel portion and the pipe segments.

6. The coupling system of claim 5, wherein the seals are configured to permit axial movement between the pipe segments and the barrel portion without diminishing the fluid pressure capabilities of the seals.

7. The coupling system of claim 1 wherein the coupler includes first seals secured to the second pipe segment inside the barrel portion and second seals secured to the second pipe segment outside the barrel portion, wherein the first and second seals prevent axial movement between the second endcap and the second pipe segment, wherein the first and second seals allow rotation of the second endcap and the second pipe segment.

8. The coupling system of claim 1 wherein the pipe segments are coupled to the skids via hammer unions.

9. The coupling system of claim 2 wherein the range of motion is between 4 and 6 inches.

10. The coupling system of claim 1 wherein the fluid pressure the endcaps prevent the fluid pressure from extending the pipe segments from the barrel portion.

11. A coupler, comprising:
a barrel portion having a first end configured to couple with a first pipe segment and a second end configured to couple with a second pipe segment, wherein rotation of the barrel portion in a first direction urges the first and second pipe segments toward one another and rotation of the barrel in the second direction urges the first and second pipe segments away from one another along a range of motion defined by an extended and contracted position; and
a first seal between the barrel portion and the first pipe segment and a second seal between the barrel portion and the second pipe segment, wherein the coupler is configured to withstand 10,000 psi and 1,600 gallons per minute.

12. The coupler of claim 11 wherein rotation of the barrel portion causes the first and second pipe segments both to move relative to the barrel portion.

13. The coupler of claim 11 wherein the first end is rotatable and axially stationary relative to the first pipe segment wherein the second end is rotatable and axially movable relative to the second pipe segment.

14. The coupler of claim 11 wherein the first pipe segment has a radially-extending shoulder and the barrel portion has a t-shaped end configured to engage with the radially-extending shoulder to prevent axial movement between the barrel portion and the first pipe segment.

15. The coupler of claim 14 wherein the barrel is threadably coupled to the second pipe segment such that rotation of the barrel portion causes axial movement between the barrel portion and the second pipe segment.

16. The coupler of claim 11 wherein the barrel portion comprises a sleeve having an interior diameter slightly larger than an outer diameter of the first pipe segment and being fixed to the first pipe segment, the sleeve being configured to receive the second pipe segment, the coupler further comprising a t-shaped member being threadably coupled to the sleeve and having a radially-inwardly extending portion configured to rotate relative to the second pipe segment while preventing axial movement between the t-shaped member and the second pipe segment.

17. The coupler of claim 11 wherein the range of motion is six inches.

18. A method of conducting fluid between adjacent skids on an oil rig at 10,000 psi and 1,600 gallons per minute, the method comprising:
providing a coupler between the skids, the coupler having a barrel portion and pipe segments protruding from opposite ends of the barrel portion, wherein the pipe segments extend and contract from the coupler when the coupler is rotated relative to the pipe segments, the coupler being sufficiently strong to withstand X fluid pressure and X flow rate;
coupling the coupler to adjacent skids; and
rotating the barrel portion to extend and contract the pipe segments.

19. The method of claim 18, further comprising conducting the fluid between the skids through the coupler at 15,000 psi.

20. The method of claim 18 wherein rotating the barrel portion causes a first pipe segment to extend relative to the barrel portion and rotating the barrel portion relative to the second pipe segment does not cause axial movement between the barrel portion and the second pipe segment.
